(19) United States
(12) Patent Application Publication
(10) Pub. No.: US 2015/0142655 A1
(43) Pub. Date: May 21, 2015

(54) METHODS, SYSTEMS AND COMPUTER READABLE MEDIA FOR APPORTIONING A PAYMENT CARD AUTHORIZATION REQUEST AMONG A PLURALITY OF ISSUER ENTITIES

(71) Applicant: MasterCard International Incorporated, Purchase, NY (US)

(72) Inventors: Debashis Ghosh, Charlotte, NC (US); Randy Shuken, Westport, CT (US)

(73) Assignee: MasterCard International Incorporated, Purchase, NY (US)

(21) Appl. No.: 14/085,776

(22) Filed: Nov. 20, 2013

(51) Int. Cl. G06Q 20/40; G06Q 20/24

(52) U.S. Cl. CPC G06Q 20/409; G06Q 20/24
USPC 705/44

(57) ABSTRACT

Methods, systems, and computer readable media for apportioning a payment card authorization request among a plurality of issuer entities are disclosed. In one example, the method includes the method includes receiving a payment card authorization request associated with a master access card account for a specified monetary amount and apportioning the specified monetary amount into a plurality of monetary amounts in accordance with predefined allocation data associated with the master access card account. The method also includes sending a plurality of authorization requests containing the plurality of monetary amounts to a respective plurality of issuer entities.

### TECHNICAL FIELD

The subject matter described herein relates to the processing of a payment transaction involving a plurality of payment cards. More particularly, the subject matter described herein relates to systems, methods, and computer readable media for apportioning a payment card authorization request among a plurality of issuer entities.

### BACKGROUND

The use of a payment card at a merchant point of sale location typically results in the communication of an authorization request from an acquirer entity to the issuer entity that is responsible for issuing the presented payment card. Notably, a payment transaction typically involves i) a single authorization request that is generated by the acquirer and ii) a single issuer that receives the authorization request associated with the payment transaction. Therefore, scenarios that involve the sending of a plurality of authorization requests associated with a single purchase transaction require that a respective plurality of payment cards must be processed at the point of sale (e.g., needing two credit cards to purchase an item). Notably, these types of purchase transactions involving two or more payment cards may be cumbersome to both the merchant entity and the customer. However, due to enforced credit limits and current account balances, there may be instances where the customer is compelled to use more than one payment card in order to conduct the purchase transaction. In such situations, the customer may experience some level of embarrassment or inconvenience that would be preferably avoided.

Accordingly, there exists a need for improved systems, methods, and computer readable media for apportioning a payment card authorization request among a plurality of issuer entities.

### SUMMARY

According to one aspect, the subject matter described herein relates to, methods, systems, and computer readable media for apportioning a payment card authorization request among a plurality of issuer entities. In one embodiment, the method includes receiving a payment card authorization request associated with a master access card account for a specified monetary amount and apportioning the specified monetary amount into a plurality of monetary amounts in accordance with predefined allocation data associated with the master access card account. The method also includes sending a plurality of authorization requests containing the plurality of monetary amounts to a respective plurality of issuer entities.

The subject matter described herein may be implemented in hardware, software, firmware, or any combination thereof. As such, the terms “function”, “node”, “unit”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for apportioning a payment card authorization request among a plurality of issuer entities according to an embodiment of the subject matter described herein;

FIG. 2 is a flow chart illustrating an exemplary method for apportioning a payment card authorization request among a plurality of issuer entities according to an embodiment of the subject matter described herein; and

FIG. 3 is a block diagram illustrating the apportioning of a payment card authorization request among a plurality of issuer entities according to an embodiment of the subject matter described herein.

### DETAILED DESCRIPTION

In accordance with the subject matter disclosed herein, methods, systems, and computer readable media for apportioning a payment card authorization request among a plurality of issuer entities are disclosed. Although the following description discloses the use of a MasterCard payment network, other third party networks or entities may utilize the methods and systems disclosed herein without departing from the scope of the present subject matter.

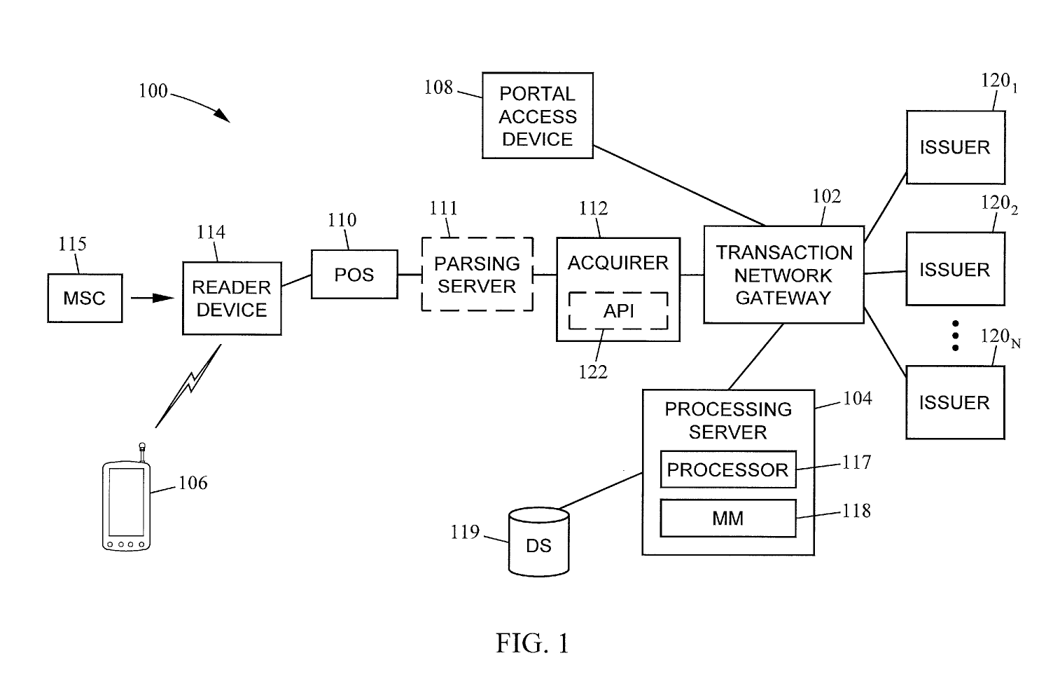

FIG. 1 depicts an exemplary purchase transaction system 100 that includes a transaction network gateway 102, a processing server 104, a web portal access device 108, a point of sale (POS) device 110, a data storage unit 119, an acquirer entity 112, and a plurality of issuer entities 120_{1 . . . N}. In an alternate embodiment, system 100 may also include a parsing server 111. FIG. 1 further depicts a magnetic stripe card 115 and a mobile device 106 that may be utilized by a user (e.g., a customer) at a reader device 114. In some embodiments, web portal access device 108 may include a computer device, a mobile smartphone device, or any other device that may be utilized by a user to access a web portal (e.g., an Internet web site). Notably, access device 108 may be utilized by a user to subscribe to a payment transaction service hosted by processing server 104 that is configured to apportion a payment card authorization request among a plurality of issuer entities. Upon subscribing, a subscriber profile may be generated and used to register the user's various payment card accounts (e.g., “payment cards”). For example, the user may utilize access device 108 to provide payment card account information for each payment card account to be registered. As used herein, payment card account information may include, but is not limited to, the payment card number (e.g., a credit card account number or primary account number (PAN)), the payment card expiration date, and the card verification value (CVV) number (if applicable), and an issuer entity identifier and/or address. In some embodiments, each payment card account registered in the user's subscriber profile is effectively designated to cover at least a portion of any forthcoming payment transaction conducted by the user's master access card (as described below). For instance, a user may register and input the aforementioned relevant payment card account information for each of a VISA prepaid card, a MasterCard credit card, an American Express credit card, and a Citibank debit card.

After provisioning and registering the subscriber profile with the payment card account information, the user may then use access device 108 to provide allocation designations for each of the payment cards. In some embodiments, the user may utilize access device 108 to assign percentage values to each of the user's registered payment card accounts. In one example, the user may respectively allocate 10%, 20%, 30%, and 40% to the user's Citibank debit card, VISA prepaid card, American Express credit card, the MasterCard credit card. Access device 108 may also be configured to provide the user the option to allocate an equal percentage value to each of the registered payment cards by default (e.g., 25% allocation to each of four payment card accounts). In some embodiments, the user may configure the subscriber profile to designate a predefined limit or threshold value in which each of the registered payment cards may be charged. In one embodiment, the web portal may be accessed using an application provisioned on a mobile device (e.g., a smart phone, a tablet computer, etc.). Such a mobile application may be utilized by a user to manage and subsequently modify the defined payment card allocations.

In some embodiments, the registered payment card accounts in the subscriber profile can be applied to the payment transaction conducted by a user in accordance to the allocated percentage values described in the predefined allocation data. Specifically, processing server 104 may apply the registered payment cards (i.e., payment card accounts) to a payment transaction in accordance to the allocated percentage values by generating separate payment card authorization requests messages. For example, after the payment card accounts have been registered and the allocation data has been designated, a subscriber user may assign on of the registered payment card accounts as the master access card account. Alternatively, the master access card account may be a separate account created for the subscriber profile by processing server 104. Once a master access card account is designated, a user may utilize an associated master access card to conduct a payment transaction. As used herein, a payment transaction may include at least one of a credit card payment transaction, a debit card payment transaction, a prepaid card payment transaction, or the like. In some embodiments, a user may initiate a payment transaction for a merchandise purchase at reader device 114 and POS device 110 at a merchant location, such as a merchant store. In some embodiments, POS device 110 may include any type of device or unit that is configured to facilitate a payment card transaction. Exemplary POS devices include self-service kiosks, self-checkout units, point of sale cashier terminals, and the like. POS device 110 may also be configured to communicate with a nearby reader device, such as reader device 114. Exemplary reader devices may include a magnetic stripe reader, a wireless smartcard reader, a wireless device reader, and the like. For example, reader device 114 in FIG. 1 may include a magnetic stripe reader that is configured to read a magnetic stripe card 115 (e.g., a plastic master access card) that is swiped by a user. Reader device 114 may also or alternatively include a wireless device reader that is configured to wirelessly communicate with a user's near field communications (NFC) enabled smartcard or mobile device 106 in order to wirelessly receive payment card information (e.g., credit card credentials) to initiate a payment transaction at POS device 110 (e.g., wirelessly receiving credit card data associated with a master access “soft card” application provisioned on the smart card or mobile device).

Upon presenting and/or interfacing the master access card (e.g., a magnetic strip card 115 or an electronic credit card provisioned on mobile device 116) with reader device 114, POS device 110 obtains credit card credentials and related data from the credit card and subsequently generates payment transaction data. Exemplary payment transaction data may include a PAN and a specified monetary amount (e.g., the dollar amount associated with the payment transaction). The payment transaction data may then be sent from POS device 110 to processing server 104 as a payment card authorization request message via transaction network gateway 102. In some embodiments, transaction network gateway 102 may include any gateway server, node, or unit that serves as an entry and exit point for communications (e.g., packet traffic) entering and leaving a payment transaction network and associated infrastructure (e.g., MasterCard network infrastructure or “MasterCard payment network”). Transaction network gateway 102 may be communicatively connected to processing server 104, which is also included within the payment transaction network.

As an alternative to receiving the payment transaction data at processing server 104, the payment card authorization request message may be first processed by either parsing server 111 or acquirer entity 112. In some embodiments, parsing server 111 may include any network element or device that is configured to recognize that the payment card authorization request message is associated with a master access card. For example, parsing server 111 may compare identifiers contained in the received payment card authorization request message with a plurality of registered master access card identifier entries stored in a database. In response to recognizing a master access card identifier (e.g., master card account number), parsing server 111 may communicate a message to processing server 104 to determine how to apportion the monetary amount specified in the original payment card authorization request message and which issuer entities 120 should receive an apportioned payment card authorization request message.

In yet another embodiment, system 100 may not include parsing server 111. Instead, acquirer entity 112 may be provisioned with an application programming interface (API) module 122 that includes a plurality of APIs configured to communicate API calls to other network elements. For example, acquirer entity 112 may be configure to utilize API module 122 to generate and send an API call to processing server 104 upon receiving a payment card authorization request message from POS device 110. For example, acquirer entity 112 may send an API call to processing server 104 in order to determine if a card account number is a master access card account number for each payment card authorization request message received by acquirer entity 112 (e.g., from POS devices). Upon receiving the API call, processing server 104 may access data storage 119 to determine if the card account number is associated with a master access card account (i.e., is a master access card account number or identifier). If so, then processing server 104 obtains and sends the corresponding allocation data (e.g., apportioned amounts and/or percentages associated with issuer entities 120) to acquirer entity 112. Once the requested information is received from processing server 104, acquirer entity 112 may use API module 122 to generate and send the apportioned payment card authorization request messages to the appropriate issuer entities 120.

In some embodiments, processing server 104 may include any server, node, computer, or unit that is configured to both i) process subscriber registrations and payment card allocation configurations and ii) process payment card authorization requests sent by POS device 110 using the methods described herein. Although FIG. 1 depicts processing server 104 as a single network element, processing server 104 may include a plurality of network elements, a plurality of network components, and/or a network itself (e.g., a MasterCard transaction network) without departing from the scope of the present subject matter. In some embodiments, processing server 104 may include a processor 117 and a management module (MM) 118. In some embodiments, processor 117 may include a microprocessor, central processing unit (CPU), or any other like hardware based processor unit that is configured to execute and/or utilize management module 118 (e.g., a software based algorithm) to communicate with a data storage unit 119 (see description below) to apportion a received payment card authorization request among a plurality of issuers respectively associated with a plurality of payment card accounts registered to a subscribed user. Management module 118 may be stored in memory (not shown), such as random access memory (RAM), read only memory (ROM), optical read/write memory, cache memory, magnetic read/write memory, flash memory, or any other non-transitory storage media. In one embodiment, processor 117 and memory may be used to execute and manage the operation of management module 118.

In some embodiments, data storage unit 119 may include any storage medium that is configured to store subscriber profile data associated with a registered user. Exemplary data storage units may include one or more external database servers accessible by processing server 104. Alternatively, data storage unit 119 may include a local database hosted by processing server 104. In some embodiments, data storage unit 119 may be provisioned with a plurality of subscriber profiles that include registered payment card account data and associated allocation data predefined by subscriber users using processing server 104.

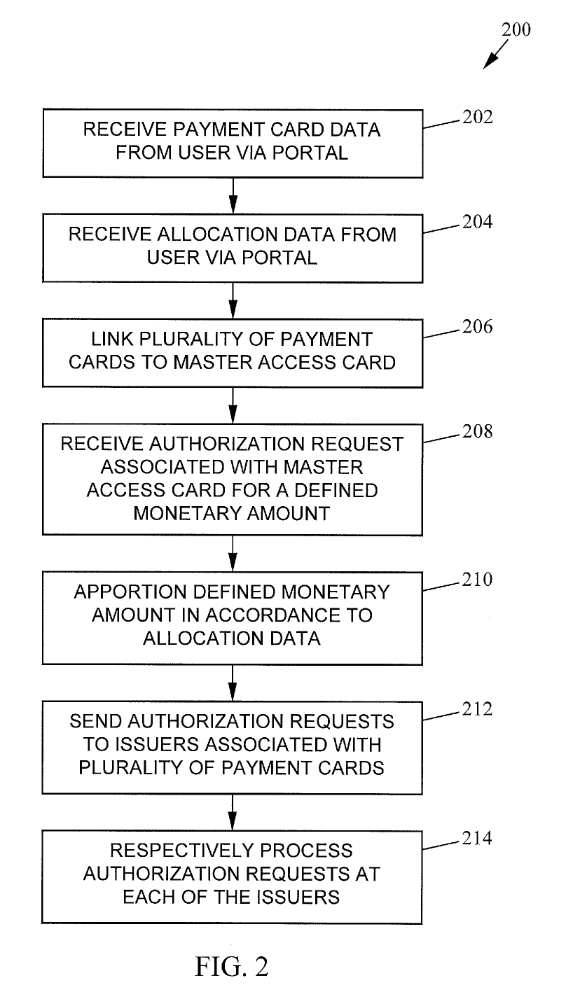

FIG. 2 is a flow chart illustrating an exemplary method 200 for apportioning a payment card authorization request among a plurality of issuer entities according to an embodiment of the subject matter described herein. In some instances below, system components described in FIG. 1 will be referenced for the purpose of providing examples of the apportioning process conducted by a processing server (e.g., method 200 may be performed by processing server 104 that executes management module 118).

In step 202, payment card data is received from a user via a web portal access device. In some embodiments, a user may utilize a computer device to access a web portal to communicate with a backend processing server (e.g., processing server 104 in FIG. 1) residing in a payment transaction network. The user may then utilize the computer device to enter payment card data associated with a plurality of payment card accounts. For instance, the user may enter the payment card number, the expiration date, the CVV number, and an associated issuer entity identifier or address for each of the payment cards the user wishes to register. In one exemplary scenario, a user may utilize the web portal to register and input the aforementioned relevant payment card data for each of a VISA prepaid card, a MasterCard credit card, an American Express credit card, and a Citibank debit card.

In step 204, allocation data is received from a user via the portal. In some embodiments, the user may utilize the web portal to assign percentage values to each of the user's registered payment card accounts. For example, the user may assign 10%, 20%, 30%, and 40% values to the Citibank debit card account, the VISA prepaid card account, the American Express credit card account, and the MasterCard credit card account, respectively. In an alternate embodiment, the web portal may be configured to assign an equal percentage value to each of the registered payment card by default. Notably, the allocation aspect of the present subject matter enables a user to effectively manage a plurality of payment card accounts in an optimal manner (e.g., leverage the accumulation of reward points, optimize interest rates associated with the payment card accounts, etc.).

In step 206, the plurality of payment cards is linked to a master access card. In some embodiments, a user may also utilize the web portal to designate one of the registered payment cards as a “master access card” (i.e., designate a master access card account). In response to such a designation, management module 118 in processing server 104 may establish a link between the other registered payment cards and the designated master access card by creating a mapping in a database. In one embodiment, management module 118 may receive master access card information from the user and may map each of the user's registered payment card account numbers to the master access card account number. In one embodiment, the master access card account number is mapped to a subscribed user's registered payment card account numbers via a web portal utilized by the subscribed user.

In step 208, a payment card authorization request associated with the master access card for a specified monetary amount is received. In one embodiment, the authorization request received at processing server 104 is made in response to a customer utilizing the master access card to conduct a purchase transaction at a point of sale (e.g., POS 110). The POS device may then communicate a payment card authorization request message to processing server 104 via transaction network gateway 102 (e.g., a MasterCard payment network gateway server). In one embodiment, processing server 104 receives a message from parsing server 111 (in response to parsing server 111 identifying the master card account number in the originally received authorization request) that indicates the specified monetary amount and a request for apportioning the specified monetary amount.

In another embodiment, processing server 104 receives an API call message from acquirer entity 112 (in response to acquirer entity 112 inquiring as to whether the card account number in the originally received authorization request) is a master access account number and a request for allocation data that may be used to apportion the specified monetary amount indicated in the original authorization request.

In step 210, the specified monetary amount in the received authorization request is apportioned in accordance to the allocation data. In some embodiments, management module 118 accesses or obtains the allocation data associated with the master access card indicated in the authorization request (e.g., using a PAN included in the authorization request) from data storage unit 119. For example, management module 118 may be configured to retrieve percentage allocation information associated with each of the subscriber's registered payment accounts (e.g., 10%, 20%, 30%, and 40% respectively allocated to a Citibank debit card account, a VISA prepaid card account, a American Express credit card account, and a MasterCard credit card account).

In step 212, a plurality of authorization requests are sent to issuer entities associated with the plurality of registered payment card accounts. In some embodiments, management module 118 generates a separate authorization request for each of the registered payment card accounts. Namely, each authorization request includes an apportioned amount that is equal to the product of the specified monetary amount in the original authorization request and the predefined allocated percentage associated with a single registered payment card account. For example, if the specified monetary amount is $2000, then a separate apportioned authorization request sent to an issuer associated with a 10% allocated percentage would be generated to include a $200 amount. Each generated authorization request would then be sent to the appropriate issuer entity using a corresponding issuer identifier or address stored in data storage unit 119.

In some embodiments, processing server 104 may be configured to provide the retrieved allocation information to the parsing server 111 or acquirer entity 112. Upon receiving the allocation information from processing server 104, parsing server 111 or acquirer entity 112 (depending on which element receives the allocation information) may subsequently generate and send the separate apportioned authorization request messages to the appropriate issuer entities 120 (i.e., instead of processing server 104).

In step 214, each of the separate authorization requests are respectively processed. In some embodiments, each of the issuer entities receives the separate and apportioned authorization request from processing server 104. After receiving the authorization request message, each issuer entity may then proceed to process the authorization request as if the authorization request was received directly from an acquirer entity.

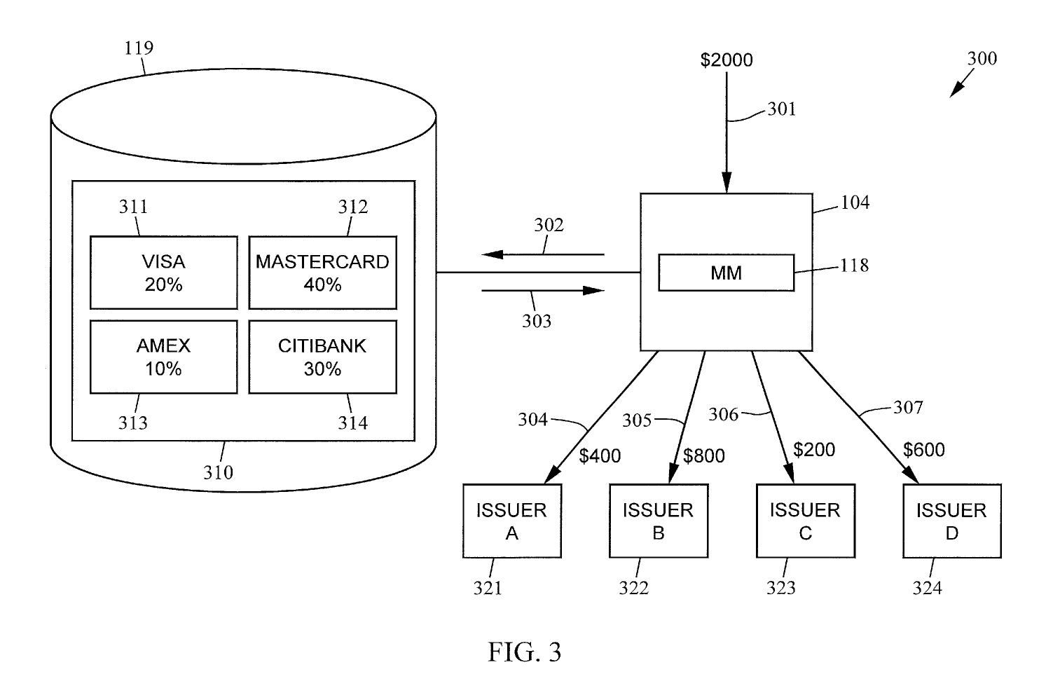

FIG. 3 is a block diagram illustrating the apportioning of a payment card authorization request among a plurality of issuer entities according to an embodiment of the subject matter described herein. For example, FIG. 3 illustrates a payment card authorization request 301 being received at processing server 104. In the depicted embodiment, authorization request message 301 includes a specified monetary amount of $2000 (e.g., associated with a $2000 credit card purchase). Upon receiving message 301 at processing server 104, management module 118 is configured to send a database query 302 to data storage unit 119. In some embodiments, the database query 302 includes a subscriber identifier and/or a master access card identifier (e.g., a PAN that was included in received authorization request message 301).

Upon receiving database query 302, data storage unit 119 may access a subscriber profile 310 containing the allocation data associated with the subscribed user (e.g., the master access card account). For example, data storage unit 119 may include a subscriber profile 310 that contains predefined allocation data 311-314. Specifically, predefined allocation data 311 may indicate that 20% of the specified monetary amount in the received authorization request is to be directed to a VISA issuer entity, predefined allocation data 312 may indicate that 40% of the specified monetary amount is to be directed to a MasterCard issuer entity, predefined allocation data 313 may indicate that 10% of an authorization request is to be directed to an American Express issuer entity, and predefined allocation data 314 may indicate that 30% of an authorization request is to be directed to a Citibank issuer entity.

In response to query message 302, a response message 303 is directed back to processing server 104. In some embodiments, management module 118 is configured to process response message 303 to determine the predefined allocation data (e.g., 20% Visa, 40% MasterCard, 30% American Express, and 10% Citibank allocations) associated with the subscribed user. In some embodiments, management module 118 may then be configured to generate a separate authorization request message for each of the payment card accounts specified in the allocation data. Namely, management module 118 may utilize the allocation data to generate authorization request messages 304-307. For example, authorization request message 304 may include a $400 (e.g., $2000×20% allocation) apportioned authorization request, authorization request message 305 may include an $800 (e.g., $2000×40% allocation) apportioned authorization request, authorization request message 306 may include a $200 (e.g., $2000×10% allocation) authorization request, and authorization request message 304 may include a $600 (e.g., $2000×30% allocation) authorization request.

FIG. 3 further illustrates management module 118 as sending authorization request messages 304-307 to respective issuer entities 321-324. In one embodiment, issuer entity 321 may be associated with VISA, issuer entity 322 may be associated with MasterCard, issuer entity 323 may be associated with American Express, and issuer entity 324 may be associated with Citibank. Upon receiving the individual authorization request messages, each of issuer entities 321-324 may process the apportioned authorization request messages 304-307 on a separate and individual basis.

In some embodiments, instead of generating and sending authorization request messages 304-307 to respective issuer entities 321-324, management module 118 may be configured to send the predefined allocation data contained in data storage unit 119 to either a parsing server or an acquirer entity (i.e., depending on which network element originally communicated with processing server 104). The parsing server or acquirer entity may then utilize the allocation data to send authorization request messages to respective issuer entities 321-324.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for apportioning a payment card authorization request among a plurality of issuer entities, the method comprising:
receiving a payment card authorization request associated with a master access card account for a specified monetary amount;
apportioning the specified monetary amount into a plurality of monetary amounts in accordance with predefined allocation data associated with the master access card account; and
sending a plurality of authorization requests containing the plurality of monetary amounts to a respective plurality of issuer entities.

2. The method of claim 1 wherein each of the plurality of authorization requests contains one of the plurality of monetary amounts.

3. The method of claim 1 wherein the payment card authorization request is associated with a payment transaction conducted with a payment card corresponding to the master access card account.

4. The method of claim 1 wherein the plurality of issuer entities is associated with a plurality of payment card accounts.

5. The method of claim 4 wherein each of the payment card accounts is linked to the master access card account

6. The method of claim 4 wherein one of the payment card accounts is designated as the master access card account.

7. The method of claim 4 wherein the predefined allocation data includes predefined percentage values associated with the payment card accounts.

8. The method of claim 4 wherein the payment card accounts include at least one of a credit card account, a debit card account, an a prepaid card account.

9. The method of claim 1 wherein sending the plurality of authorization requests includes generating a separate payment card authorization request for each of the plurality of monetary amounts.

10. The method of claim 1 wherein the predefined allocation data is assigned by a user via a web portal.

11. The method of claim 1 wherein the predefined allocation data is modified via a mobile device application.

12. A system for apportioning a payment card authorization request among a plurality of issuer entities, the system comprising:
a plurality of issuer entities configured for receiving a plurality of authorization requests; and
a processing server configured to receive a payment card authorization request associated with a master access card account for a specified monetary amount, to apportion the specified monetary amount into a plurality of monetary amounts in accordance with predefined allocation data associated with the master access card account, and to send the plurality of authorization requests containing the plurality of monetary amounts to the plurality of issuer entities.

13. The system of claim 12 wherein each of the plurality of authorization requests contains one of the plurality of monetary amounts.

14. The system of claim 12 wherein the payment card authorization request is associated with a payment transaction conducted with a payment card corresponding to the master access card account.

15. The system of claim 12 wherein the plurality of issuer entities is associated with a plurality of payment card accounts.

16. The system of claim 15 wherein each of the payment card accounts is linked to the master access card account

17. The system of claim 15 wherein one of the payment card accounts is designated as the master access card account.

18. The system of claim 15 wherein the predefined allocation data includes predefined percentage values associated with the payment card accounts.

19. The system of claim 15 wherein the payment card accounts include at least one of a credit card account, a debit card account, an a prepaid card account.

20. The system of claim 12 wherein the processing server is further configured to generate a separate payment card authorization request for each of the plurality of monetary amounts.

21. The system of claim 12 wherein the predefined allocation data is assigned by a user via a web portal.

22. The system of claim 12 wherein the predefined allocation data is modified via a mobile device application.

23. A non-transitory computer readable medium having stored thereon executable instructions for controlling a computer to perform steps comprising:
receiving a payment card authorization request associated with a master access card account for a specified monetary amount;
apportioning the specified monetary amount into a plurality of monetary amounts in accordance with predefined allocation data associated with the master access card account; and
sending a plurality of authorization requests containing the plurality of monetary amounts to a respective plurality of issuer entities.
